(19) United States
(12) Patent Application Publication
(10) Pub. No.: US 2009/0199275 A1
(43) Pub. Date: Aug. 6, 2009

(54) WEB-BROWSER BASED THREE-DIMENSIONAL MEDIA AGGREGATION SOCIAL NETWORKING APPLICATION

(76) Inventors: David Brock, Natick, MA (US); Pano Anthos, Wellesley, MA (US); Michael Mittelman, Boston, MA (US)

Correspondence Address: CHOATE, HALL & STEWART LLP, TWO INTERNATIONAL PLACE, BOSTON, MA, 02110, US

(21) Appl. No.: 12/027,032

(22) Filed: Feb. 6, 2008

(51) Int. Cl. H04L 9/32; G06F 3/048; G06F 15/16

(52) U.S. Cl. 726/4; 715/753; 715/757; 715/716; 715/719; 709/203

(57) ABSTRACT

Systems and methods for social networking and digital media aggregation represented as a three-dimensional virtual world within a standard web browser are described. In one embodiment, multiple, independent groups of users interact with each other inside a dynamic, three-dimensional virtual environment. These groups may be mutually exclusive and members interact only with other members within the same group. In this manner, system architecture and server requirements may be greatly reduced, since consistent environmental state needs to be maintained only for a small number of interacting participants—typically less than one dozen.

### BACKGROUND OF THE INVENTION

Social networking and media sharing have emerged as a rapidly growing segment of the Internet. Numerous commercial applications exist, yet many rely on standard two-dimensional Hyper-Text Markup Language (HTML) web page layouts.

Computer three-dimensional graphics hardware has existed for some time, but only recently has this capability be available on lower end, consumer-oriented systems. This advance has been fueled primarily by rapid increase of immersive three-dimensional video games. As of 2004, 75% of American households play video games, and games sales reached nearly 250 million units—almost two games for every home in the United States.

Broadband access to the home has recently reached critical mass. In 2005 home broadband adoption grew 20%, and in 2006 40%, until today where a majority of homes in the United States have access to high speed internet. This advance has lead to a plethora of digital media sharing web sites, and provides a necessary component of this present invention.

Finally, user experience-particularly among younger users (13-25 years)—has changed dramatically in recent years. Today instant access and continuous communication through high-speed networks may be expected, and has become a component in daily life.

### SUMMARY OF THE INVENTION

The invention generally relates to social networking and digital media aggregation represented as a three-dimensional virtual world within a standard web browser. Novel approaches to human-machine interaction and digital media sharing are accomplished through a unique assemblage of technologies. In one embodiment, multiple, independent groups of users interact with each other inside a dynamic, three-dimensional virtual environment. These groups are mutually exclusive and members interact only with other members within the same group. In this manner, system architecture and server requirements are greatly reduced, since consistent environmental state needs to be maintained only for a small number of interacting participants—typically less than one dozen.

In one aspect, the present invention relates to methods for providing, in a web browser, a shared display area allowing user interaction and media sharing. In one embodiment such a method includes: displaying, in a first web browser to a first user on a first computer, a shared environment navigable by the first user; receiving, from the first user, input corresponding to an interaction with at least one object in the shared environment; perceptibly reproducing, in response to the input, a media file in the environment in the first web browser; displaying, in a second web browser to a second user, the shared environment; and perceptibly reproducing, in response to the input from the first user, the media file in the environment in the second web browser.

In another aspect, the present invention relates to systems for providing, in a web browser, a shared display area allowing user interaction and media sharing. In one embodiment such a method includes: means for displaying, in a first web browser to a first user on a first computer, a shared environment navigable by the first user; means for receiving, from the first user, input corresponding to an interaction with at least one object in the shared environment; means for perceptibly reproducing, in response to the input, a media file in the environment in the first web browser; means for displaying, in a second web browser to a second user, the shared environment; and means for perceptibly reproducing, in response to the input from the first user, the media file in the environment in the second web browser.

### BRIEF DESCRIPTION OF THE DRAWINGS

The following detailed description of the illustrated embodiments may be further understood with reference to the accompanying drawings in which:

FIG. 1 is a block diagram illustrating one embodiment of a network with a number of clients and servers;

FIG. 2 illustrates an example of a user login screen, in which user identification and authentication information may be entered to access a virtual environment;

FIG. 3 shows an example of a user welcome page listing one or more virtual environments from which a user may select;

FIG. 4 illustrates an example of an invitation page, which allows a user to ‘invite’ friends to join him or her in a virtual environment;

FIG. 5 shows an example of a room creation page;

FIG. 6 illustrates an example of a virtual environment;

FIG. 7 illustrates an example of a text chat window;

FIG. 8 illustrates an example of a user interface for controlling a virtual television;

FIG. 9 shows an example of an interface for audio selection, playback and control;

FIG. 10 shows an interface for sharing images;

FIG. 11 shows an example of a virtual magazine;

FIG. 12 shows an example of a virtual gift;

FIG. 13 shows an example of a whiteboard 1301 on which users may draw;

FIG. 14 shows an example of a three-dimensional virtual environment embedded in a third-party social networking application;

FIG. 15 is a flow chart illustrating one embodiment of a method for providing, in a web browser, a shared display area allowing user interaction and media sharing.

### DETAILED DESCRIPTION OF THE INVENTION

In one embodiment of the invention all physical simulation and environment visualization are implemented on the user's computer—not the central server. Thus, complex computation is distributed across the network, greatly easing the server requirements and enabling rapid system scaling.

In this embodiment, messages between members of a group are routed from one client to another through a central server. This provides a virtual peer-to-peer network, which greatly simplifies communication between peers behind a Network Address Translation (NAT) router or firewall, and provides a means to record events. Environmental state change messages between peers and between client and server are in the form of the Extensible Markup Language (XML), while digital media—images, audio and video—use common industry standard formats.

In one illustrative embodiment, the web server operates MICROSOFT WINDOWS SERVER 2003 manufactured by Microsoft Corporation and implements the open source Apache Software Foundation, APACHE HTTP Server. The PHP Group, PHP Language provides server-side support scripting and dynamic web page support. In addition, FLEX and ACTIONSCRIPT 3.0 both from Adobe Corporation, support the development and deployment of cross platform, rich Internet applications based on their proprietary Macromedia FLASH platform. Relational database support is provide by MySql managed by MySQL AB, a multithreaded, multi-user SQL database management system. In this embodiment, any server-side scripting language may be used to support dynamic web page content, including without limitation PHP, JSP, and Microsoft Active Server Pages.

Other embodiments may substitutes APACHE HTTP Server with the Microsoft Internet Information Services (IIS), which is a set of Internet-based services based on Microsoft Windows. In these embodiments, PHP server-side scripting may be replaced with Microsoft Active Server Pages (ASP.NET), which is a web application framework, which allows developers to build dynamic web sites, web applications and extensible Markup Language (XML) Web Services. Finally, Microsoft SQL Server, a relation database management system, may provide database services.

In addition to the preceding two embodiments, alternatives are consistent with the disclosure and do not depart from the spirit of the invention. These alternatives may include (1) operating systems UNIX, LINUX, SOLARIS and Mac OS, (2) server frameworks Java 2 Platform Enterprise Edition (J2EE), JBOSS Application Server, RUBY ON RAILS, and many others, (3) relations databases, such as Oracle™ and PostgreSQL, FIREBIRD and DB2 and (3) scripting languages Phython, PERLand Java Server Pages (JSP).

Various embodiments may support any commercial or non-commercial web browsers, including without limitation Microsoft INTERNET EXPLORER, Mozilla FIREFOX, Apple SAFARI, OPERA maintained by Opera Software ASA, and AOL NETSCAPE NAVIGATOR.

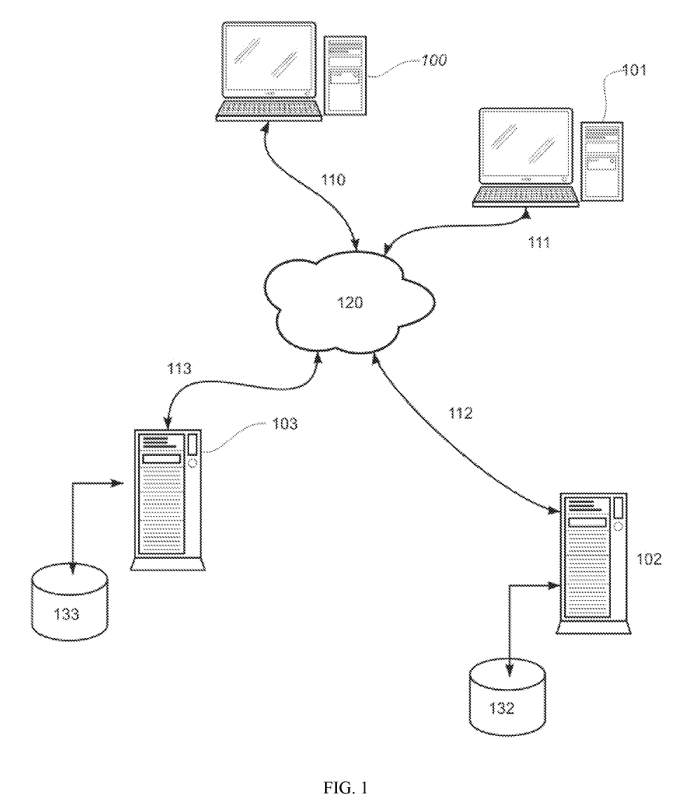

FIG. 1 illustrates one embodiment of a network with a number of clients and servers. In brief overview, a client-server model is used to, among other things, maintain user information, manage login sessions, link external data resources and coordinate communication between networked peers.

Still referring to FIG. 1, now in greater detail, clients 100 and 101 may comprise any computing device capable of sending and receiving information, including without limitation personal computers, laptops, cellular phones or personal digital devices. A client may communicate with other devices by any means include without limitation the Internet, wireless networks or electromagnetic coupling.

A network 120 enables communication between systems that may include any combination of clients and servers. The network may comprise any combination of wired or wireless networking components as well as various network routers, gateways or storage systems.

Network connections 110 to 113 represent communications means to and from a network 120. These connections 110 to 113 may allow any encoded message to be exchanged to and from any other computational system or combination of computations systems, including without limitation client and server systems.

A server 102 may comprise a computing system that manages persistent and dynamic data, as well as communication between clients and other servers. More specifically server 102 may facilitate client-to-client communication and assist in the management of simulated environment.

A database storage system 132 may maintain any user and simulated environment information. The database may comprise a relational database system, flat-file system or any other means of storing and retrieving digital information.

A remote server 103 may comprise any computational storage and data retrieval system that contains any third party data, including without limitation audio, video, images or text, or any textual or binary information.

A database storage system 133 represents a digital information storage means maintained by a third party provider.

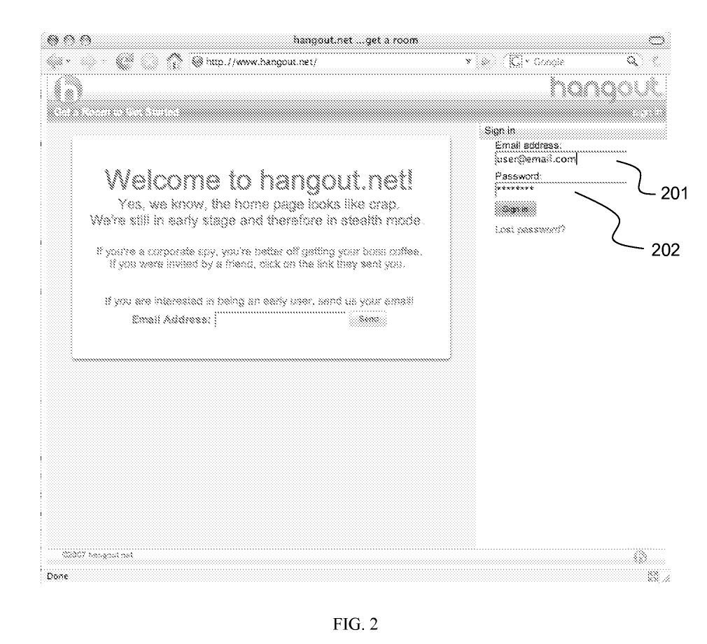

A first user on a client 100 accesses a server 102 through a network 120 via communication means 110 and 112. The first user provides authentication information, such as username and password, via an input screen, illustrated by example in FIG. 2. This user authentication information is communicated to the server 103. The server compares the provided user authentication information with that storage in a database 132.

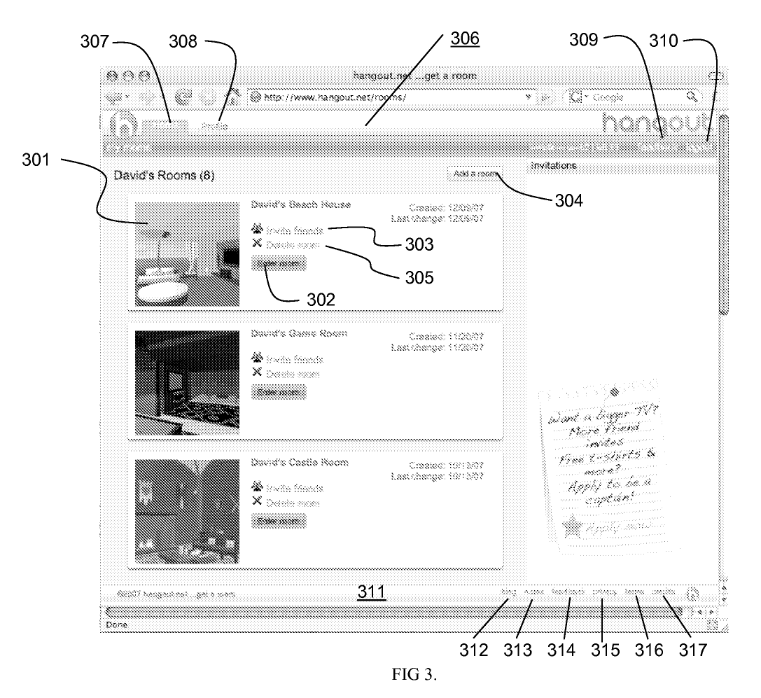

If the provided information is valid, that is if the user authentication information matches that stored in the server database, the first user has “logged in” to the server, and may at this point select from a set of virtual environments, as illustrated by example in FIG. 3. Information describing the virtual environments may be maintained by a server 102, which also manages the user authentication information, or, in an alternative embodiment, by a separate server that also communicates with the client.

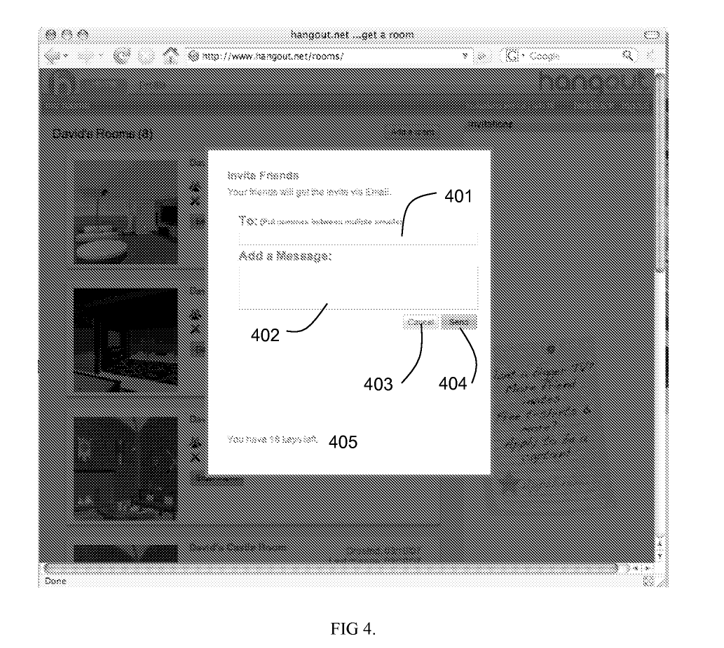

When the first user selects a virtual environment, some or all of the information necessary to describe that environment may be communicated to the client. In an alternative embodiment, all the information about the virtual environment may be management entirely on the server. In either case, a virtual environment may be presented to the user, as illustrated by example in FIG. 4.

The first user may interact with the virtual environment in various means and using interface mechanisms of the client computational system. These mechanisms may include, but are not limited to, a computer keyboard, mouse, trackball, touch pad, touch screen, key pad, or any other means well known in the art of human machine interface devices.

A second user on client 101 may access server 102 via communication means 111 and 112 through a network 102. The second user may “log in” to server 102 using the same procedure as the first user. In other embodiments, alternative login methods and credentials may be used by the second user or any subsequent user.

A second user on client 101 may receive from the first user on client 100 a message containing information related to the virtual environment used by the first user. The message may be sent from the first user to the second user using any of the various means common in digital communication. These include, but are not limited to, electronic mail, instant message applications, text messaging, electronic forums or internet bulletin boards.

In one embodiment, the message send from the first user to the second user may contain a uniform resource locator (URL), or internet link, that allows the second user to select and then automatically enter the same virtual environment as the first user. In this case, the second user may perceive actions of the first user within the virtual environment, and conversely actions by the first user may be perceived by the second. By this method, an illusion may be achieved, in which the first and second users are perceived to occupy the same virtual space, and may interact with each other within that space through a variety of means. These interactions may include, but are not limited to text messaging, voice chat, or interaction through various simulated artifacts that occupy the shared virtual environment.

In one embodiment, a first user may be designated as an “owner” of a virtual environment, which may grant to that user certain privileges. These privileges may include that ability to specify or reconfigure aspects of the virtual environment. These aspects may include the (1) creation or inclusion of virtual objects or virtual effects, (2) configuration or positioning of virtual objects or virtual effects, (3) coloring or texturing of virtual objects or virtual effects, or (4) manipulation of any perceived aspect of the virtual environment. Furthermore these aspects may be temporary, existing only for a particular user session, or permanent, existing for any future session or interaction in the virtual environment.

In another embodiment, the privileges granted to the “owner” may include the ability to restrict or include any additional users that may be allowed to enter or interact in one or more virtual environments. These additional users over which the “owner” may grant access may be termed “friends.” In addition, the “owner” may further restrict user assess or interaction based on certain circumstances, such as whether the “owner” is currently present in one or more of these virtual environments. These virtual environments may be designated as the “property” of a particular “owner,” in which the rights to control assess may be limited to that “owner.” These embodiments may be extended to include, without limitation, any restriction or assess to any feature or interaction within one or more virtual environments by any user or set of users specified by any other user or set of users.

Communication necessary to simulate interaction between first and second users may be achieved by sending messages between clients 100 and 101. In one embodiment, a message sent from client 100 is first communicated to server 102 through network 102 and subsequently relayed to client 101 via the same network. Conversely messages sent from client 101 may be relayed to client 100 via the server 102 and network 120. Through this method, some or all messages sent between clients 100 and 101 are managed by server 102 and may be filtered, stored, analyzed or in any way manipulated in whole or in part as the messages are relayed between clients.

In an alternative embodiment, messages between clients 100 and 101 may be sent directly to each other through the network 120 without using server 102. Using peer-to-peer methods well know in the art, client systems may establish bi-direction communication channels through networks without intervening servers.

Messages sent between clients and servers may adopt any combination of standards, protocols and languages used in the various layers of network communication. These may include at the physical layer, Ethernet standard hardware, modems, power-line communication, wireless local area networks, wireless broadband, infrared signaling, optical couplings, or any wired or wireless physical communication means. At the data level, standard protocols may be used such as the Institute of Electrical and Electronics Engineers (IEEE) 802 standards, Asynchronous Transfer Mode (ATM), Ethernet protocol, Integrated Services Digital Network (ISDN), and many others. Networking and transport layer communications methods may include User Datagram Protocol (UDP), Transmission Control Protocol (TCP), Real-Time Transmission Protocol (RTP), or other transport methods. Application level communication methods vary widely, and may include the HyperText Transfer Protocol (HTTP), Extensible Markup Language (XML) messaging, SOAP (originally Simple Object Access Protocol), Real Time Streaming Protocol (RTSP), Short message peer-to-peer protocol (SMPP), or any of the other well-known messaging standards for media and information.

FIG. 2. illustrates an example of a user login screen, in which user identification and authentication information may be entered in order to gain access to protected information, which may include virtual environments, customization systems and user profile information.

Referring to FIG. 2., now in more detail, text input area 201 may accept user identification information; such as user name, screen name, email or any other identification means.

Text area 202 may receive user authentication information, such as a password, response to personal query or any other cryptic entry preferably known only to the user.

In the current embodiment, text input areas 201 and 202 accept user email and password respectively, using a standard Hypertext Markup Language (HTML) web page. These information are transmitted to the server 103 using the Hypertext Transmission Protocol (HTTP) POST method.

In other embodiments, alternative login, user authentication or presentation methods may be used. For example, these methods may include electromagnetic strip cards, radio frequency identification (RFID), static biometrics (e.g. images of fingerprints, face, iris, retina, etc.), dynamic biometrics (e.g. movement patterns or behavior from keyboard, mouse, handwriting, etc.), Global System for Mobile communications (GSM) Subscriber Identity Module (SIM) cards (e.g. cell phones, smart phones, etc), USB tokens, template on board (e.g. Flash drive, contact-less cards, etc.), memory-less cards or tokens; as well as any combination of these or other authentication technologies.

FIG. 3. shows an example of a user welcome page. A welcome page may list one or more virtual environments from which a user may select. These virtual environments may provide on-line, collaborative spaces in which a number of on-line, solitary or collaborative activates may occur and are described herein. An initial page may also include the ability to (1) add, delete or edit a virtual environment, (2) invite another user to a specific virtual environment, (3) provide feedback on the product or (4) logout of the system.

A thumbnail image 301 may provide a representation of a virtual environment, and button 302 may allow a use to enter that virtual environment. Text link 303 may also allow a user to invite friends to a virtual environment. This invitation system will be described in more detail in FIG. 4.

Additional virtual environments, which in the present embodiment are termed as rooms, may be added using button 304. The term room in the current embodiment is synonymous with a generic virtual environment in which one or more users may interact, and is not limited to indoor environments.

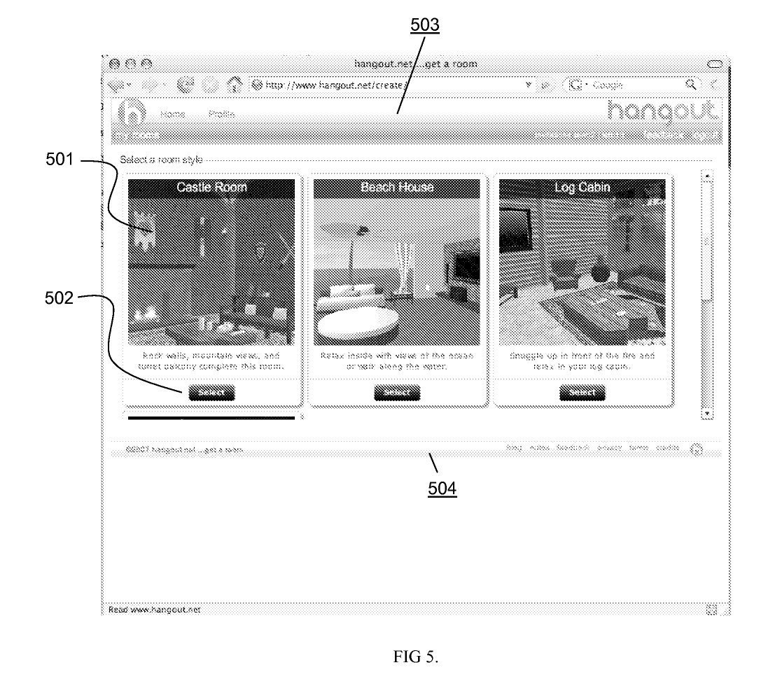

Button 305 may allow a user to add a new room to their inventory. This room creation system will be described in more detail in FIG. 5.

A header region 306 may provide generic navigation and user information. This header region may include navigation back to the home page 307, user profile page 308, feedback section 309 and logout 310. Alternative configuration and navigation schemes, include various placement, links, text or graphics, are consistence with the intention of this input area.

Finally, footer region 311 may allow additional user navigation, which may include links to various feedback, forums, corporate, personal and legal pages. Text link 312 may navigation to a user forum or ‘blog’, link 313 to product release notes, 314 to user feedback page, and links 315,316, and 317 to corporate privacy, terms of use and credit pages respectively. Alternative embodiments for the footer configuration, or for any section of the user welcome page, are consistent with the scope of this embodiment.

FIG. 4. illustrates an example of an invitation page, which allows a user to ‘invite’ friends to join him or her in a virtual environment. In this embodiment, text input area 401 allows a user to identify an invitee by that person's email address. Alternative identification schemes may also be used, such as the user's full name, nickname, screen name, address, phone number, or any other common means to identification.

Text input are 402 may allow a personal message or greeting to be attached to the invitation. Additional media or information may be sent along with the invitation, including any imagery, audio, video or text. Buttons 403 and 404 sends or cancels the message respectively.

Label 405 may indicate the number of keys or invitations that have been sent to various users, as well as the number of keys remaining from a finite number. These keys may enumerate or limit the number of user allowed to access the system. Alternative embodiments may eliminate the display or use of keys, or vary the depletion or number of keys based on various metrics, such as invitation usage, frequency, novelty, or any other measure of product use.

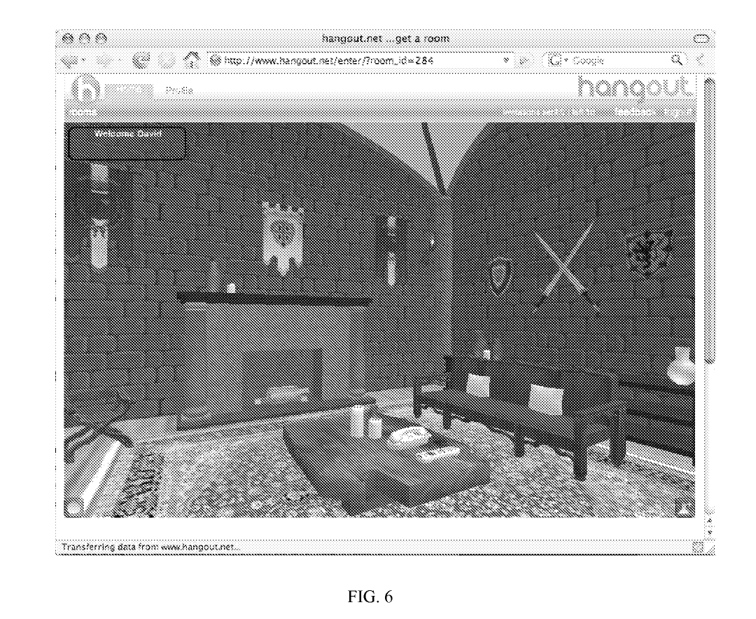

FIG. 5. shows an example of a room creation page. In the present embodiment, a list of stylized rooms may be presented to a user. This list may include a thumbnail image 501 and selection button 502. Depressing the select button 502 may automatically add the corresponding room to the user's inventory and immediately places the user in that virtual environment, which is described in more detail in FIG. 6. Similar to those shown in FIG. 4., generic header 503 and footer 504 regions may present user information and navigation means. Alternative embodiments allowing the creation of additional virtual environments may include a simple textual list, three-dimensional presentation, or any other means for enumerating and displaying a list.

FIG. 6. illustrates an example of a virtual environment. A virtual environment may be presented within a web page as an embedded web object or may occupy the entire video screen. In either case, this environment may comprise any number of virtual artifacts, images, media, persona or other representations of real or imaginary objects. A user may interact with the environment through a variety of means, including, without limitation, keyboard commands, mouse movement, voice input, motion sensors, game controllers or an other human-machine interface.

Still referring to FIG. 6, now in further detail, a virtual environment may be implemented in any manner, including without limitation a Java Applet, web browser plug-in or standalone application. In one embodiment, the virtual environment may be implemented using the UNITY game engine developed by Over the Edge, Inc. The virtual environment may also include support for three-dimensional visualization, real-time interaction, direct computer graphic hardware access, physics simulation, scripting and network communication, as well as other means to enhance and support virtual environment creation and interaction.

A user may navigate through a virtual environment in using a variety of methods. For example, users may move forward, back, left and right, as well as rotate to the left and right, thus mimicking the experience of being physically present in the virtual environment that is depicted on the screen. In one embodiment, these movements are affected by keyboard input. In other embodiments, various input means may be used, including without limitation mouse movement, button click, voice input, game controller or any other means for human-machine interaction.

In addition to moving within a virtual environment, a user may also control the view within the same environment using a variety of means, including keyboard input, mouse movement, button click, voice input, game controller or other human-machine interaction.

Objects within the virtual environment may react to user input in a variety of ways; include, without limitation, those that mimic the behavior of real objects in the physical world. For example, objects may behave as if acted upon by gravity and physical contact. These objects may be push, pulled, carried, throw, arrange or manipulated in any manner, including those that simulate real-world interaction. In addition, objects that resemble manufacture items, such as televisions, stereos, telephones, lights, fans, air-conditioners, refrigerators, etc., may appear to mirror the behavior of their real-world counterparts.

Simulating the function and appearance of real-world artifacts and natural objects is only a part of the capability of the virtual environment. The following figures illustrate, by means of example, various features of the virtual environment, as well as methods for human-to-machine and human-to-human interaction.

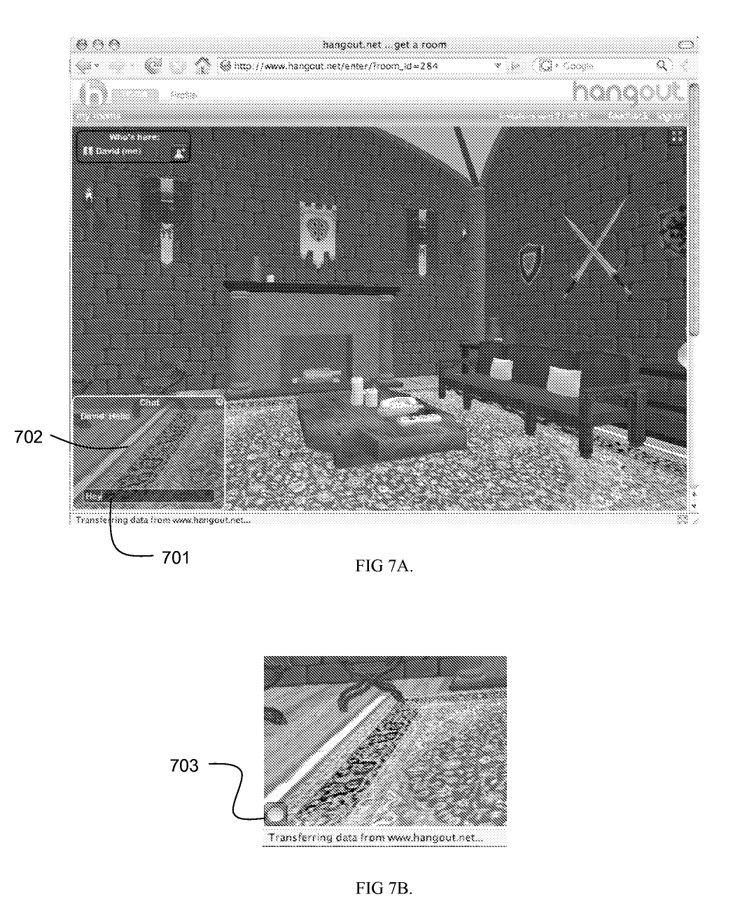

FIG. 7. illustrates an example of a text chat window. In this window, users may enter messages that may be display to other users on different computers. A list of messages that were sent and received may be displayed as a running history within a window. In the current embodiment, users within the same virtual environment view the same message history. Alternatives embodiments, however, may limit messages to only a selected subset of users within the same virtual environment, or may expand message interchange to a large set of users independent to the virtual environment they occupy. Other embodiments may include the ability to send and receive messages to users using any other messaging systems, including without limitation third-party systems, such as ICHAT from Apple Corporation, INSTANT MESSAGE from America Online, Inc., or GOOGLE CHAT from Google, Inc.

Still referring now to FIG. 7. in greater detail, text input area 701 may accept user keyboard input. Alternative methods for text input may include speech-to-text, mouse selection of pre-defined text, or other means of created or selected character strings.

Text display area 702 may display a list of previously entered text input. These input may originate from the current user or any other user or computer in communication to the virtual environment.

Exit button 703 allows the user to minimize the text input area. This area, once minimized, may be restored by user selection of an icon, such as that illustrated in FIG. 7B.

The text input and display areas 701 and 702 provide the user the ability to send and receive messages to and from other users within the same virtual environment.

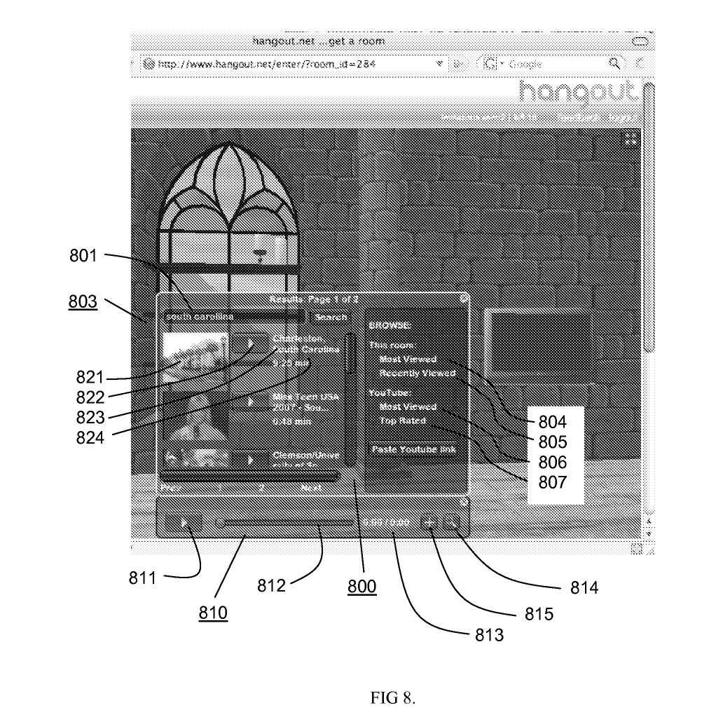

FIG. 8. illustrates an example of a user interface 800 for controlling a virtual television. This interface may allow a user to search for, select, manipulate and display media for presentation on the virtual television screen.

Text input area 801 may allow a user to enter search criteria for media archived on remote resources. These remote resources may include media from YouTube™ managed by Google, Inc., as well as media from MySpace™, Metacafe™, DailyMotion™, Google Video™, or a host of media sharing websites. These media sharing websites may allow users to upload, view, manipulate and share audio, video and imagery media. Button 802 initiates a search on the aforementioned remote resources for media having criteria that match those entered by the user in text area 801.

Display area 820 may present a list of media, including a representative thumbnail image 821, text description 822, media duration 823, play button 824 or other media descriptive or controlling element.

Panel 803 may provide an area for selecting the display of preferred media. The display of these media may be controlled by text buttons, which may include a button for the most frequency consumed media 804 and those most recently consumed 805 by users of the virtual environment. The panel 803 may also include buttons 806 and 807 for displaying the media most recently viewed and most highly rated by users of remote media archives. Selecting any of these buttons 804-807 may list media in display area 803 for subsequent user selection.

Panel 810 of the media interface 800 may provide various controls and displays for manipulating and describing the presented media. These may include a play/pause button 811 for starting and stopping the media, and a progress slide 812 and time indicator 813 for representing current location and total time of the selected media. The media title area 814 may display the name of the currently selected media or any other related information. Button 815 may automatically move the user to a position within the virtual environment directly in front of the media display. In this way, viewing of the media may be greatly enhanced. Finally, button 816 may re-display panel 803 if such panel should be hidden.

Entering search criteria in area 801 and pressing button 802, or alternatively selecting any button 804-807, initiate a search of the remote media resources. Results from the search may be displayed in area 820. Pressing the play button for particular media item, may then present that media item on a virtual object, which in the present embodiment is a virtual television. Alternative embodiments may present media, such audio, video, text, imagery, animations or other information on other virtual surfaces or objects.

More precisely, selecting a media item may initiate a message sent from the client computer 100 to the server 103. This message may be resent to the original sender as well as all the other users within the virtual environment. This message may contain information such as the location on the network of the remote media asset, as well as other information such as whether to stream or download that asset or where along the duration of the media playback should start. Once this message is received by the client computer, that system may initiate access to the remote media asset for playback within the virtual environment. Since messages may be received by the client computers at approximately the same time, media presentation may be approximately synchronized among all the participants within the environment. This presentation may be synchronized even among participants who arrive midway through a presentation. For example, if a user begins playing a movie on a screen in the environment, and then a second user joins one minute later, the second user may see the movie beginning at the one-minute mark of the movie.

The user interface 800 may be displayed by selecting a virtual remote control 850, television set 851 or, other objects within the virtual environment. In other embodiments, selected a menu item, keyboard command, mouse click, voice input or other human-machine interface message may launch the media interface 800 or another other specialized interface.

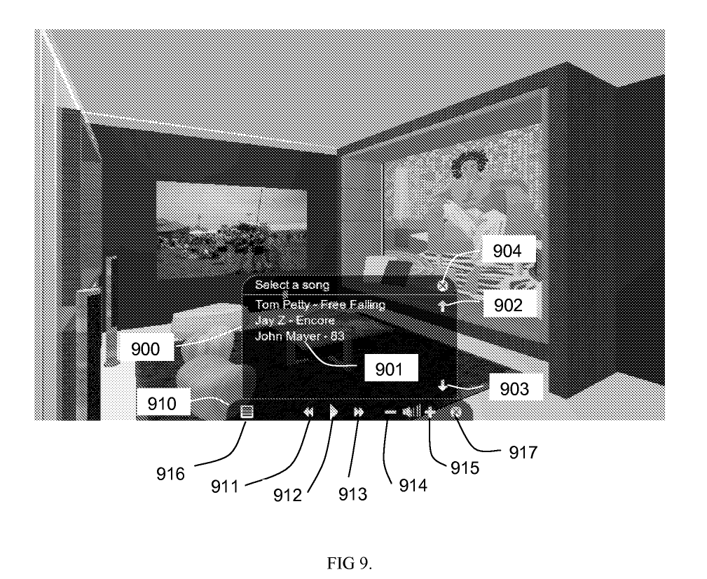

FIG. 9. shows an example of an interface for audio selection, playback and control. This interface may include two panels 900 and 910. Panel 900 may present a list of audio tracks 901, which in the present embodiment display the artist and track title. Other embodiments may display a variety of textual and imagery data, such as track duration, album name, genre, rating, frequency of play, thumbnail image, etc. Arrow buttons 902 and 903 may move the audio list up or down respectively.

Panel 910, as an example in this embodiment, may include control buttons 911 to play a preceding track and 913 to play a subsequent track from the list in panel 900. Toggle button 912 may alternatively play or pause the selected track. Volume may be controlled by buttons 914 and 915 that raise or lower volume respectively. List button 916 redisplay the selection list panel 900 should the panel become hidden. Finally buttons 904 and 917 may hide panels 900 and 910 respectively.

Similarly to the media control system described in FIG. 8., selecting a track from the audio list 901 may send a message from the client computer 100 to server 103. This message may be resent to all users in the virtual environment, including the original sender. When an audio play message is received by a client computer, this system may intimately access and playback of the remote audio track.

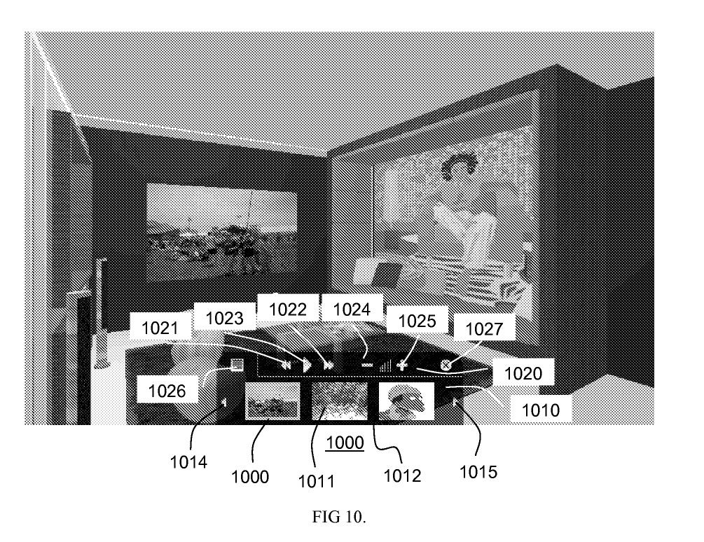

FIG. 10. shows an interface 1000 for sharing images. Using this interface, users may select images shored on various image sharing websites, such as MySpace™, Facebook™, Flickr™, Photobucket™ and many others. Image sharing interface 1000 may include two panels, 1010 and 1020.

Panel 1010 may provide a list of image catalogs, which may be displayed using representative thumbnail images 1011 along a scroll bar 1012. An image catalog may be selected by pressing the thumbnail image, after which an outline 1013 may be presented around the thumbnail indicating the selection. Image catalogs may be advanced forward and back using arrow buttons 1014 and 1015 respectively.

Panel 1020 may include buttons to control the display of images stored within particular image catalogs. Button 1021 and 1022 may advance a selected image within a catalog forward and back respectively. A play/pause button 1023 may allow the automatic advancement of images within a catalog in the form of a ‘slideshow.’ The plus and minus buttons 1024 and 1025 speed and slow the delay between the display of images of the slideshow. List button 1026 may re-display panel 1010 should that panel be hidden. Finally, exit button 1027 hides the interface 1000.

Image catalogs presented in panel 1010 may be acquired from catalog information stored on image sharing websites. The representative thumbnail images 1011 may be constructed from images stored in each of the on-line catalogs. User may advance forward or backward the image catalog until a desired catalog image is displayed. This catalog may be selected by pressing the thumbnail image. Selecting a particular catalog may import the image list onto the client computer. At this point the actual image files may be downloaded from the media sharing site as necessary.

Users may select a particular image from the catalog by iteratively clicking through the set using arrow buttons 1021 and 1022. A timed slide show may also be initiated or terminated pressing the play/pause button 1023. The rate at which new images are presented during the slide show may be adjusted faster or slower using the plus 1024 or minus 1025 buttons respectively.

Images retrieved from the media website may be presented on objects within the virtual environment, such as wall hangings, pictures frames, television screens, photo albums or any other surface or object within virtual environment. In the present embodiment images may be displayed on a large poster 1030 within the virtual environment.

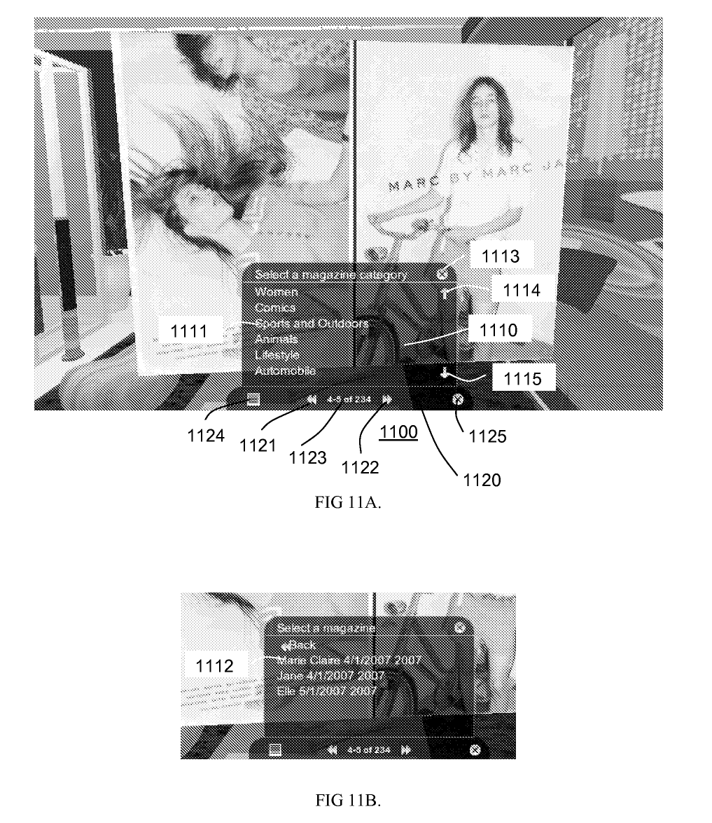

FIG. 11. shows an example of a virtual magazine. The virtual magazine may mimic some of the features associated with magazines in the real-world, such as the flipping pages, and move closer or further away from the page. The control of the virtual magazine may be augmented by a magazine interface 1100. This interface may include two panels 1110 and 1120.

Panel 1110 may include a list 1111 of magazine categories by genre, such as women's interest, men's interests, comics, sports, outdoors, etc. Selecting a genre may replace the categories with a list of particular magazines, as shown in FIG. 11A. Panel 1110 may then display a list 1112 specific magazine titles and issue dates, from which a user may select.

Panel 1120 may provide buttons 1121 and 1122 that advance the magazine page forward and back, simulating the behavior of a real magazine. The center page indicator 1123 may display the current page and the total page length. Similarly to the other user interfaces, a list button 1124 may re-display the top panel 1110 should it be hidden, and exit buttons 1113 and 1125 hide their respective panels.

Selecting a magazine from the list 1112 sends a message from the client computer 100 to remote server 103 that may contain magazine page images. These images may be downloaded, as needed depending current pages displayed by the user. In other embodiments, all or some page images may be downloaded as quickly as possible and then cached. Magazine page advancement forward and back may be achieved using buttons 1121 and 1122 or by simply clicking on the respective page using the mouse.

While magazine images were displayed in the current embodiment, other embodiments may allow a user to select areas of the page image. In this manner particular advertisements or products displayed within advertisements may be selected. Product information may then be presented to the user, or alternatively, direct web access may be allowed. More specifically, a selected product image may launch a representation of a web browser within the virtual environment, or may launch an actual web browser with the web link corresponding to the advertisement.

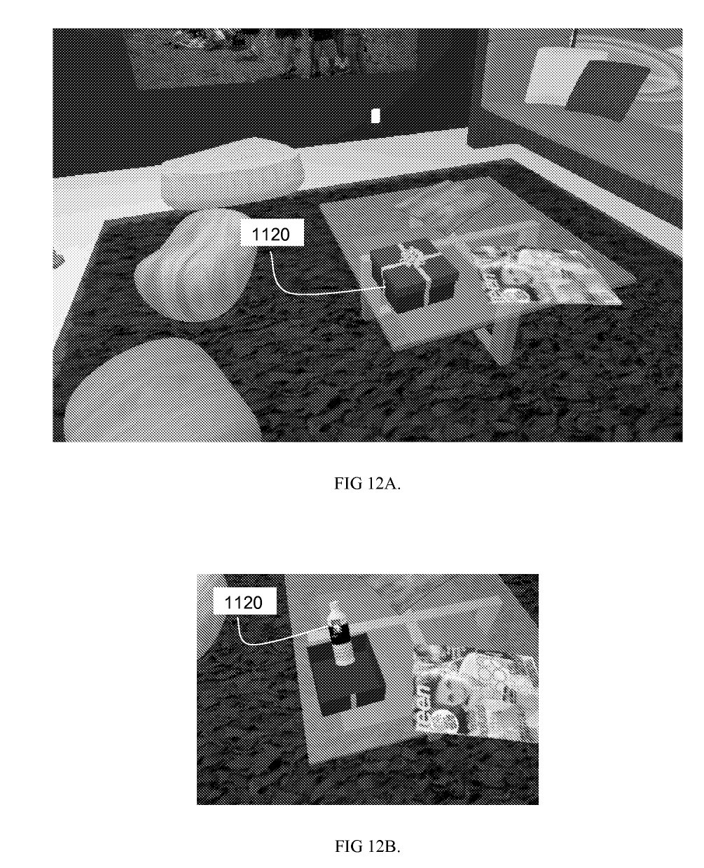

FIG. 12. shows an example of a virtual gift. As presents are sent and received in the real-world, the virtual environment allows virtual gifts to be exchanged among users.

Package 1200 illustrates an example of a virtual present, complete with wrapping paper, ribbon and bow. The wrapping paper, ribbons, bows, cards, personal messages, etc. may be customized by the sender of the gift.

Selecting the gift, in this embodiment, caused the top to be removed and the contents forcefully ejected. Other embodiments may simulate packaging unwrapping, shredding, dissolving, exploding, fading, or any other means to artfully remove the covering from view.

The package contents 1210 shown in this embodiment were a drink container. In other embodiments nearly any real or imagined object may be presented as a gift. As the virtual environment is not bound by the physical laws of the real world, imaginative gifts are possible. These virtual gifts may include items too small for the package, such virtual furniture or appliances that grown when released. In this manner it is possible to send and receive any object in the virtual world using a gift metaphor.

As an example, as one possible embodiment, selecting the gift caused an external web browser to launch with information from a website about that particular gift.

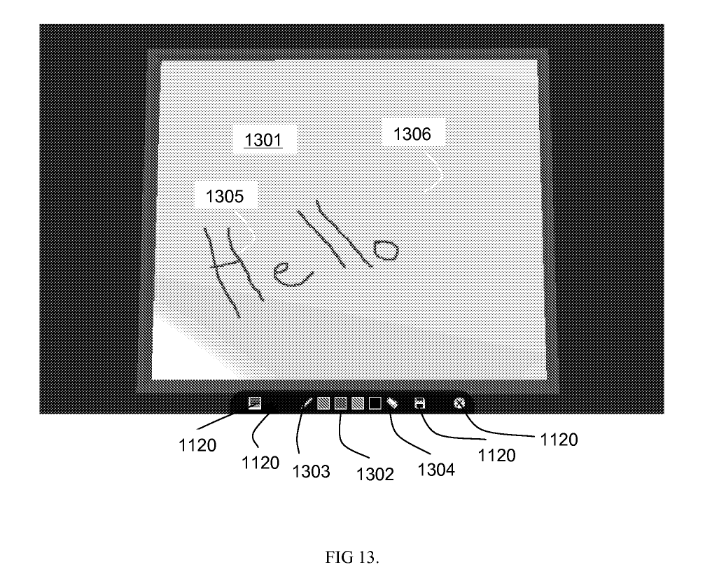

FIG. 13. shows a representation of a whiteboard 1301 on which users may draw. Users may select colors 1302 for a virtual marker 1303 or select an eraser 1304 to erase previous marks. Depressing a mouse button and moving it cases a straight or curved line 1305 to be drawn on the screen 1306. Information about this line—color, width, position, length, etc—is transmitted to the other client computers of users within the same virtual environment. In this manner, users may share the experience of drawing on a common object, much as they would in the physical world.

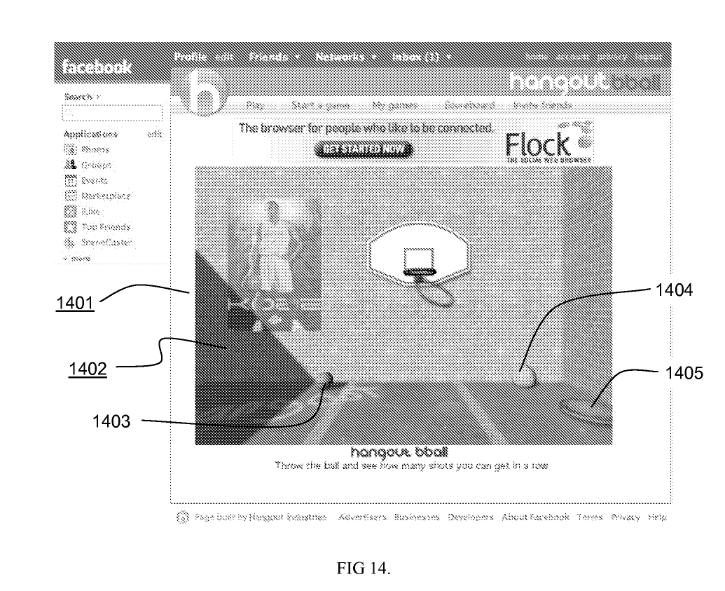

FIG. 14 shows an example of a three-dimensional virtual environment embedded in a third-party social networking application. In this particular example, the FACEBOOK application is illustrated, though any social networking website could also used, and may including without limitation MYSPACE, HABBO, ORKUT, and many others. Also this example illustrates an alternative embodiment of a virtual environment.

A basketball simulation 1401 may include a virtual environment 1042 that may represent any real or imagined virtual space, such as a backyard, alley, playground, stadium, or any other spatial representation. In this embodiment, the user may move the cursor over a virtual object 1403-1405, such as a basketball, beach ball, pizza, horse, anvil, or any real or fanciful object in order to ‘pick-up’ or ‘capture’ that object. Once the object is selected subsequent mouse movement may move that object within the virtual space. Releasing the mouse button may simulate the ‘release’ or ‘throw’ of that object, after which the object's movement may be directed by simulated physics, which may include influences of simulated gravity, wind, temperature, physical contact, or any other force that may be present in the real or simulated worlds. Although a basketball simulation is show in this embodiment any virtual environment or feature within a virtual environment heretofore described may also be included in this implementation.

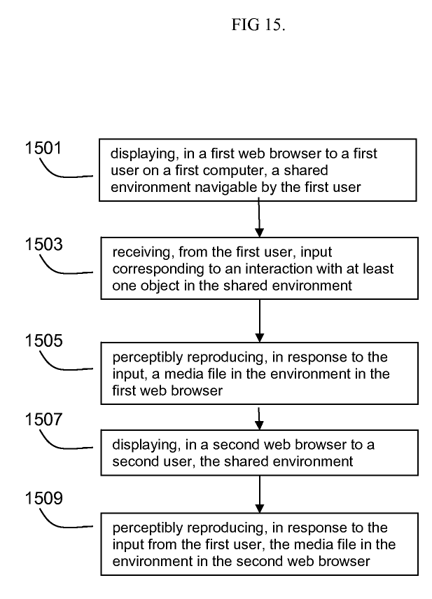

Referring now to FIG. 15, a flow chart illustrating one embodiment of a method for providing, in a web browser, a shared display area allowing user interaction and media sharing is shown. In brief overview, the method comprises: displaying, in a first web browser to a first user on a first computer, a shared environment navigable by the first user (step 1501). The first computer receives, from the first user, input corresponding to an interaction with at least one object in the shared environment (step 1503) and perceptibly reproduces, in response to the input, a media file in the environment in the first web browser (step 1505). A second computer may display, in a second web browser to a second user, the shared environment (step 1507); and perceptibly reproduce, in response to the input from the first user, the media file in the environment in the second web browser (step 1509).

Still referring to FIG. 15, now in greater detail, a shared environment navigable by a first user may be displayed in a web browser in any manner (step 1501). In some embodiments, the shared environment may be displayed on a web page with other web page elements. In other embodiments, the shared environment may be displayed in a separate window by the browser. The shared environment may comprise any of the environments described herein, including without limitation virtual rooms, houses, outdoors, and game environments. The environment may be navigable by the user in any manner, including without limitation mouse, keyboard, joystick, touchpad, gamepad, or any combination of input devices. In some embodiments, the environment may provide a first-person perspective. In other embodiments, the environment may provide a third-person perspective. In some embodiments, a user may navigate the environment in three dimensions. In other embodiments, a user may have three-dimensional control of a camera.

A first computer may receive input from a user corresponding to an interaction with at least one object in the shared environment (step 1503). In some embodiments, the object in the environment may represent a real-world object typically associated with a media type, such as a television, radio, poster, or book. The user may interact with such an object using any interface. In some embodiments, the user may interact with an interface displayed on the object in the environment. In other embodiments, a separate interface may pop up or otherwise be displayed allowing the user to interact with the object. The interaction may specify any type of media or media interaction. In some cases, an interaction may comprise a user hitting “play” or “stop” or “pause” or “fast forward” or similar actions. In other cases, an interaction may comprise a user identifying a media file, such as by browsing a directory or entering a filename or URL.

The first computer may then perceptibly reproduce a media file in the environment in any manner (step 1505). In some embodiments, the first computer may play audio corresponding to an audio file. In other embodiments, the first computer may display a video on an object in the environment. In still other embodiments, the first computer may display a photograph on an object or wall in the environment. In some embodiments, the media file may reside locally on the first computer. In other embodiments, some or all of the media file may be streamed to the first computer.

A second computer may display, in a second web browser to a second user, the shared environment in any manner (step 1507). In some embodiments, the second computer may display the shared environment from the perspective of an avatar of the second user. In some embodiments, the shared environment may be navigable by the second user. In some embodiments, the second computer may display a representation of an avatar of the first user in the shared environment.

The second computer may then perceptibly reproduce, in response to the input from the first user, the media file in the environment in the second web browser (step 1509). In some embodiments, the reproduction by the second computer may occur substantially simultaneously with the reproduction by the first computer. For example, the first computer and second computer may each display a video playing on a television screen within the environment, such that the video display is substantially synchronized between the computers. In this example, an interaction from one user, such as pausing, fast forwarding, or rewinding the video, may be reflected on both computers substantially simultaneously.

Any of the various features of the invention disclosed herein may be employed in a wider variety of systems. Those skilled in the art will appreciate that modifications and variations may be made to the above disclosed embodiments without departing from the spirit and scope of the invention:

What is claimed is:

1. A method for providing, in a web browser, a shared display area allowing user interaction and media sharing, the method comprising:
a. displaying, in a first web browser to a first user on a first computer, a shared environment navigable by the first user;
b. receiving, from the first user, input corresponding to an interaction with at least one object in the shared environment;
c. perceptibly reproducing, in response to the input, a media file in the environment in the first web browser;
d. displaying, in a second web browser to a second user, the shared environment; and
e. perceptibly reproducing, in response to the input from the first user, the media file in the environment in the second web browser.

2. The method of claim 1, wherein the shared environment is a three-dimensional virtual environment.

3. The method of claim 2, wherein the shared environment allows the first user to adjust a viewing angle in three dimensions.

4. The method of claim 2, wherein the shared environment is navigable by the first user in three dimensions.

5. The method of claim 1, further comprising the manipulation of said media file by the first user and displaying said manipulation to the second user.

6. The method of claim 1, further comprising transmitting communication between said first user in the first web browser and the second user in the second web browser.

7. The method of claim 6, wherein said communication comprises text interchange between the first user and the second user.

8. The method of claim 6, wherein said communication comprises audio interchange between the first user and the second user.

9. The method of claim 1, wherein the media file encodes video information.

10. The method of claim 1, wherein step (e) comprises perceptibly reproducing, in response to the input from the first user, the media file in the environment in the second web browser substantially simultaneously with the reproducing of the media file in the first web browser.

11. The method of claim 1, wherein step (e) comprises perceptibly reproducing, in response to the input from the first user, the media file in the environment in the second web browser substantially simultaneously with the reproducing of the media file in the first web browser.

12. The method of claim 1, further comprising displaying, in the first web browser to the first user, a list of a plurality of shared environments for which the first user has permission to enter.

13. A system for providing, in a web browser, a shared display area allowing user interaction and media sharing, the system comprising:
means for displaying, in a first web browser to a first user on a first computer, a shared environment navigable by the first user;
means for receiving, from the first user, input corresponding to an interaction with at least one object in the shared environment;
means for perceptibly reproducing, in response to the input, a media file in the environment in the first web browser;
means for displaying, in a second web browser to a second user, the shared environment; and
means for perceptibly reproducing, in response to the input from the first user, the media file in the environment in the second web browser.

14. The system of claim 13, wherein the shared environment is a three-dimensional virtual environment.

15. The system of claim 14, wherein the shared environment allows the first user to adjust a viewing angle in three dimensions.

16. The system of claim 14, wherein the shared environment is navigable by the first user in three dimensions.

17. The system of claim 13, further comprising means for manipulating said media file by the first user and means for displaying the manipulation to the second user.

18. The system of claim 13, further comprising means for transmitting communication between said first user in the first web browser and the second user in the second web browser.

19. The system of claim 18, wherein said communication comprises text interchange between the first user and the second user.

20. The system of claim 18, wherein said communication comprises audio interchange between the first user and the second user.

21. The system of claim 13, wherein the media file encodes video information.

22. The system of claim 13, comprising means for perceptibly reproducing, in response to the input from the first user, the media file in the environment in the second web browser substantially simultaneously with the reproducing of the media file in the first web browser.

23. The system of claim 13, comprising means for perceptibly reproducing, in response to the input from the first user, the media file in the environment in the second web browser substantially simultaneously with the reproducing of the media file in the first web browser.

24. The system of claim 13, comprising means for displaying, in the first web browser to the first user, a list of a plurality of shared environments for which the first user has permission to enter.
